(19) United States
(12) Patent Application Publication
(10) Pub. No.: US 2007/0174490 A1
(43) Pub. Date: Jul. 26, 2007

(54) System and methods for managing content in pre-existing mobile applications

(75) Inventors: Andrew C. Choi, Burlingame, CA (US); James L. Durrell, Collegeville, PA (US); Michael M. Chang, San Francisco, CA (US)

Correspondence Address: JAMES E. EAKIN, P.O. BOX 1250, MENLO PARK, CA, 94025-4317, US

(73) Assignee: Greystripe Inc., San Francisco, CA (US)

(21) Appl. No.: 11/656,172

(22) Filed: Jan. 19, 2007

Related U.S. Application Data
(60) Provisional application No. 60/762,445, filed on Jan. 25, 2006.
(60) Provisional application No. 60/800,101, filed on May 11, 2006.
(60) Provisional application No. 60/859,327, filed on Nov. 15, 2006.

(51) Int. Cl. G06F 15/16

(52) U.S. Cl. 709/246

(57) ABSTRACT

Methods and systems for managing distribution and retrieval of data (for example advertising content and viewing statistics) and insertion of control logic (for example display of advertising content) into pre-existing mobile applications. In some arrangements the method includes analyzing the pre-existing application in the context of the target platform and the desired placement of new content, and instrumenting the application to support the addition of the new content. The instrumenting process can include modification of the application to support one or more of features selected from a group comprising user identification, usage tracking, bi-directional communication with an advertising server, and displaying advertising content. The analysis and instrumenting process can be applied in a just-in-time fashion during application download. In some arrangements, a portal application can be provided to reside on the mobile device for managing communications with an advertising server.

### RELATED APPLICATIONS

This application claims the benefit of, and incorporates by reference, each of the following United States Provisional Patent applications, each of which has the same inventive entity and is assigned to the same assignee: Ser. No. 60/762,445, filed Jan. 25, 2006, entitled “System and Methods for Managing Content in Pre-Existing Mobile Applications”; Ser. No. 60/800,101, filed May 11, 2006, entitled “System and Methods for Managing Content in Pre-Existing Mobile Applications”; and Ser. No. 60/859,327, filed Nov. 15, 2006, entitled “System and Methods for Managing Content in Pre-Existing Mobile Applications.”

### FIELD OF THE INVENTION

The present invention relates primarily to data management techniques for mobile devices and to pre-existing applications for such devices, and more particularly relates to methods and techniques for modifying existing mobile applications to permit either of both insertion of content adapted for operation on the target device, and retrieval of appropriate user and usage information from the device.

### BACKGROUND

Most mobile applications (those designed to run on mobile devices, such as cell phones, smart phones, PDAs, and portable game consoles) are developed in languages such as Java and C++. The source code for these applications must be compiled into an object code format and packaged (typically in conjunction with application resources and application descriptor files) for distribution. If an application publisher wishes to introduce new functionality into an existing application, the application source code must be modified, recompiled, and redistributed. FIG. 1 [PRIOR ART] shows the distribution path of an application 100 from the application publisher 105 to the application distributor 110 (which in some cases the same entity as the publisher), through the wireless carrier network 115, and ultimately to an end user's mobile device 120.

There are many examples of useful functionality that could be added to a mobile application after it has been developed and sent to an application distributor. A primary example of additional functionality is receipt and display of advertising content, although numerous other examples of such functionality exist, including: billing and subscription management, market research, personalization, and networked game support.

A large number of mobile applications have been developed which are provided to end users free of charge and which provide no direct revenue to the application publishers. In fact, in the U.S. market, usage of such free applications exceeds usage of purchased applications by an order of magnitude. Application publishers are interested in monetizing these applications via advertising content, but most have not yet done so due to the cost of retrofitting application source code. Further, to date, there has been no viable method for retrieving appropriate user data to assist in monetizing these applications.

There has, therefore, been a long-standing need for systems and techniques for managing distribution of data (such as advertising content) and for retrieval of appropriate data (such as advertising impression counts) to and from pre-existing mobile applications.

Existing web advertising systems such as DoubleClick distinguish between the concepts of advertisements and creatives in that an advertisement is a collection of creatives, where all creatives within a collection are images of the same dimensions. The advertisement collection construct helps the advertiser organize creatives based on similarities in advertising message. Such advertising systems first select an ad for placement in a specific website location (this selection is often manually configured) and then select from the creatives within the ad collection. Because all creatives within an ad collection share the same image dimensions, image dimension is not included in the criteria for creative selection. More generally, existing online advertising systems assume that all creatives can be presented (displayed and interacted with) on all computers that attempt to view the website into which the creative is served. Because different devices have differing capabilities and this has not been addressed by existing web ad systems, there has been a need for a system for serving ads which takes into account the differing capabilities of the device to which the ad is being served. This is particularly true for mobile devices.

### SUMMARY OF THE INVENTION

The present invention substantially improves upon the prior art by providing systems, methods and techniques for adding content and control logic to pre-existing applications for mobile devices and also for retrieving user and usage data from such mobile devices. In at least some arrangements, the techniques include analyzing the pre-existing application in the context of its target platform, identifying appropriate points for insertion of the new content and control logic, and automatically rewriting the application to permit the new content to be supplied and control logic to be invoked at the appropriate times. An aspect of the invention is directed to a business method for the distribution of content and the apportionment of revenues according to the roles of the participants in that distribution.

### BRIEF DESCRIPTION OF THE DRAWINGS

FIG. 1 [PRIOR ART] shows in flow diagram form the distribution path of a mobile application from the application publisher to the end user mobile device.

FIG. 2 shows one example of an arrangement of a mobile application distribution path in accordance with the system of this invention for the purpose of distributing advertising content.

FIG. 3 is a UML sequence diagram which illustrates the rewriting process in accordance with the present invention as used in the mobile application distribution prior to a request for distribution of the application to a mobile device.

FIG. 4 is a UML sequence diagram which illustrates the rewriting process in accordance with the present invention as used in the mobile application distribution subsequent to a request for distribution of the application to a mobile device.

FIG. 5 is a flow diagram showing the steps of code rewriting according to the present invention.

FIG. 6 is a system block diagram of the instrumentation server showing the analysis and rewriting modules and their interaction with a configuration database and optional external systems.

FIG. 7 is a UML sequence diagram which illustrates one example of how certain of the components of FIG. 6 can interact.

FIG. 8 shows in block diagram form the components of a mobile application developed in Java.

FIG. 9 is a diagram showing the results of applying the code rewriting process of FIG. 5 to the mobile application of FIG. 8.

FIG. 10 is a diagram showing a more detailed view of the classfile components of FIG. 8.

FIG. 11 is a diagram showing how the mobile application of FIG. 8 can be divided into two applications for the purpose of reducing the size of individual applications.

FIG. 12 is a diagram showing how the distribution package file size of the mobile application of FIG. 8 can be reduced by removing resource files and retrieving them instead at runtime.

FIG. 13 is a UML sequence diagram showing the runtime behavior of a mobile application instrumented according to the present invention.

FIG. 14 is a UML sequence diagram showing the runtime behavior of a mobile application instrumented according to the present invention, in cooperation with a portal application.

FIG. 15 is a UML sequence diagram showing the runtime behavior of one or more cooperating mobile applications instrumented according to the present invention.

FIG. 16 is a UML sequence diagram showing the interaction of the inventory emulator of one embodiment with ad content servers to provide targeted ads.

FIG. 17 illustrates an example of an instrumented application as displayed to the user, with presplash and postsplash screens.

FIG. 18 is a diagram showing an example flow of applications, advertisements, statistics, and payments in a commercial application of this invention.

FIG. 19 is a diagram showing an example arrangement of the conventional mobile application distribution path which has been augmented with the system of this invention for the purpose of application billing and subscription management.

FIG. 20 is a diagram showing an example arrangement of the conventional mobile application distribution path which has been augmented with the system of this invention for the purpose of gathering market research data.

FIG. 21 is a diagram showing an example arrangement of the conventional mobile application distribution path which has been augmented with the system of this invention for the purpose of personalizing application content.

FIG. 22 is a diagram showing an example arrangement of the conventional mobile application distribution path which has been augmented with the system of this invention for the purpose of communicating game scores to a networked score server.

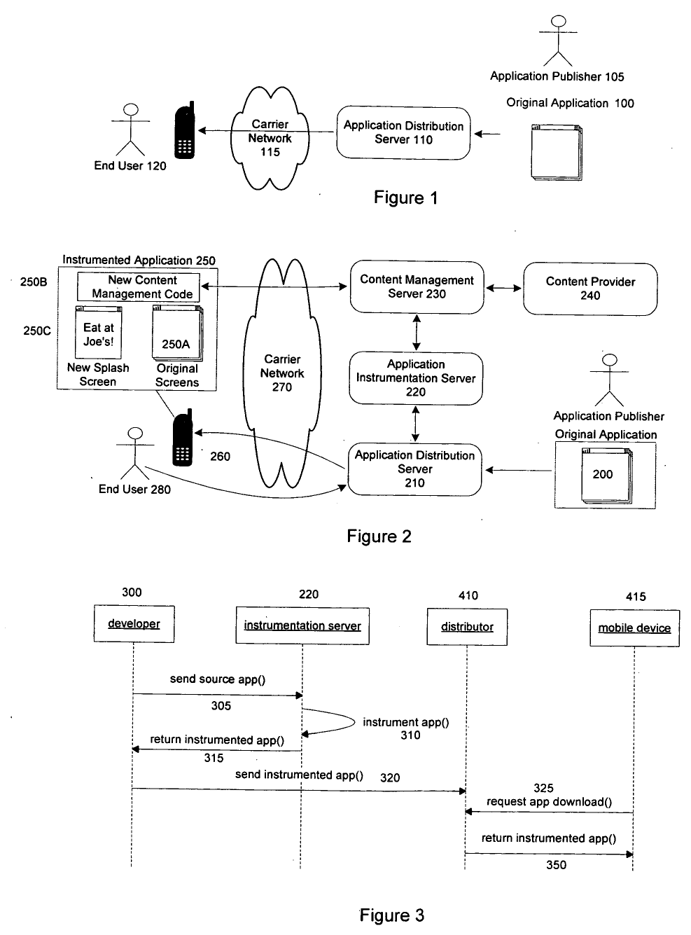

### DETAILED DESCRIPTION OF THE INVENTION

FIG. 2 shows one example of an arrangement in accordance with the invention for distribution of mobile applications. A mobile application publisher (or “developer”) has developed an application, which for purposes of clarity herein is referred to as a pre-existing (or “original”) application 200. In one arrangement, the application publisher sends the original application to an application distribution server 210, which sends the application to the application instrumentation server 220 for processing. It will be appreciated that the servers shown herein are illustrated as single devices for purposes of clarity, but can comprise one or more servers and associated storage elements, either co-located or distributed across a network including the internet. Likewise, where a database is described, it will be appreciated by those skilled in the art that the ‘database’ can in fact be comprised of one or more databases, located either locally or spread across a network including the internet.

In an alternative arrangement, which is preferable in at least some instances, the application publisher sends the original application 200 first to the application instrumentation server 220 and then to the distribution server 210. Upon receiving an original mobile application, the instrumentation server 220 performs the analysis and instrumentation methods which are aspects of this invention. The analysis and instrumentation methods include analyzing the mobile application in object code form and adding, deleting, or modifying the constituent object code instructions. After an original application has been subjected to analysis and instrumentation, it is referred to for purposes of the present invention as an “instrumented application”. The application distribution server 210 transmits (distributes) an instrumented mobile application to an end user's mobile device 260 in response to an end user request for download.

In some arrangements, the analysis and instrumentation methods results in the addition of new control logic to the application. One example of such additional control logic is the capability of retrieving, rendering, and reporting viewing statistics for advertising content. Placement opportunities (such as screen regions) for such advertising content are conventionally known as “inventory”. In one arrangement of the present invention, content is added to the application during instrumentation, in which case the instrumentation server retrieves content from a content management server 230, which can include storage for such information, or can alternatively receive content from a separate content provider 240. Alternatively, content can also be retrieved at runtime by the new control logic from a content management server; in addition to retrieving content, in some arrangements the new control logic uploads information to the content management server such as content viewing statistics. The instrumented application 250, which in the illustrated example comprises the original screens 250A plus new content management code 250B, plus one or more new splash screens 250C, is then distributed in a conventional manner to a suitable receiver such as a cellular telephone 260 or other similar device over the carrier network 270, where the instrumented application 200 is provided to the user 280.

Examples of advertising content, as referred to above, include both input and output elements. Output elements include graphical elements, such as splash screens, which are typically displayed before application execution, after application completion, or between application screen transitions. Output elements can also include graphical elements such as banners, marquees, flyovers, pop-ups, and videos, all of which can be shown at various times during application execution, potentially in combination with existing application graphical content. Output elements can also include other known output mechanisms such as audio content or tactile content, such as device vibration. Input elements typically involve opportunities for users to enter data or make choices, and can for example take the form of user interface (“UI”) text boxes or selection controls. Input elements are used, for example, in conjunction with output elements to create interactive content, such as customer surveys or lead generation, such as email acquisition. Input elements can also include monitoring of lower-level input mechanisms such as touch-sensitive screen, tilt sensor, accelerometers, special function buttons, and switches indicating phone mechanical configuration. Input elements can also include monitoring of low-level input and data sources that are not typically under direct user control, including for example radio signal receiver status and data, GPS chipset status and data, RFID transceiver status and data, IR transceiver status and data, Bluetooth transceiver status and data, clock, camera, and light sensors.

A single application can be instrumented multiple times, resulting in multiple instrumented versions of that application, and each instrumented version can have support for different advertising content. A single application can be instrumented multiple times, over a period of time, such that later instrumented versions can have support for advertising content not existing at the time of the prior instrumentations. In this manner, as advertising content types (also known as ad formats) are created over time, a given application can be re-instrumented to include support for each new ad format.

The following sections provide further detail on aspects of instrumentation initiation, analysis and instrumentation methods, object code modification techniques, and runtime system interactions for an instrumented mobile application.

### Initiation of Application Instrumentation

As described previously, the instrumentation process is initiated when an original application is provided to the instrumentation server either by the developer prior to application distribution or by the distribution server during application distribution.

FIG. 3 shows one example of an arrangement by which an application is instrumented prior to distribution. The developer 300 completes development of a mobile application and, at 305, sends the original application to the instrumentation server 220, which instruments the application as shown at 310 according to the methods described below and, at 315, returns the instrumented application to the developer. Then, at 320, the developer sends the instrumented application to the distributor. Finally, the mobile device sends a request to the distributor to download the application as shown at 325, and the distributor returns the instrumented application as shown at 350.

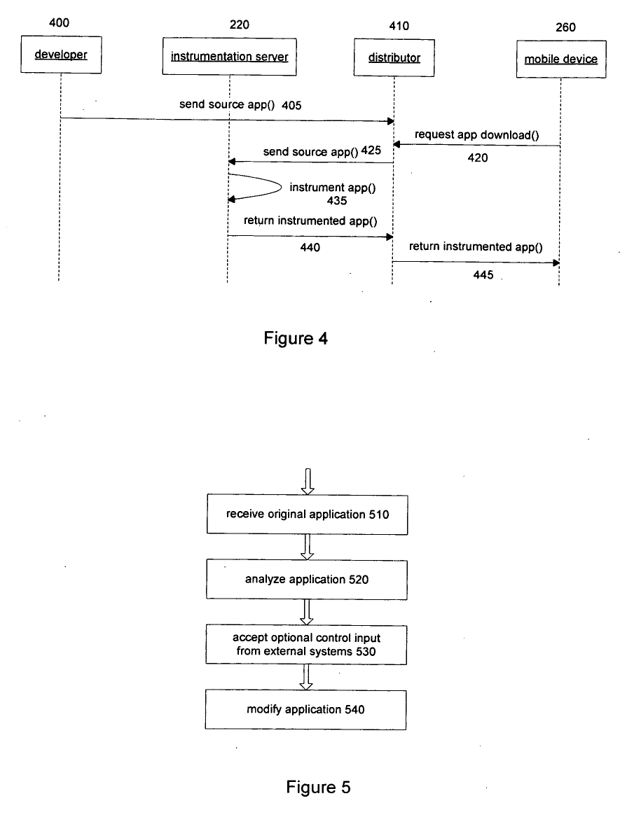

FIG. 4 shows an alternative arrangement in which an application is instrumented during distribution. The developer 400 completes development of a mobile application and, as shown at 405, sends the original application to the distributor 410. A mobile device 260 sends a request to the distributor 410 to download the application as shown at 420. The distributor typically knows the mobile device or user identity from the context of the download request, although other techniques are known in the art and any suitable technique can be used. At 425, the distributor sends the original application and optionally the mobile device/user identity to the instrumentation server 220, which instruments the application as shown at 435 and returns the instrumented application as shown at 440. The instrumentation server 220 can instrument the application such that the resulting application incorporates information related to the distributor(s) identity, user identity, and target mobile device. At 445, the distributor then returns the instrumented application to the mobile device. In this latter case, the instrumentation server has the ability to instrument the application for retrieval and/or rendering of ad content that is targeted specifically to the requesting mobile device, user, and or distributor.

In a further alternative arrangement, a combination of both approaches can be used, such that an application undergoes multiple instrumentation steps, some before and some during the distribution process. An application can also be instrumented or re-instrumented after it has been downloaded to a mobile device. Such instrumentation is performed either by the instrumentation server code executing on the mobile device; or by uploading the application from the device to an instrumentation server, instrumenting the application, and then downloading the application back to the device. It will be appreciated by those skilled in the art that numerous other permutations can be used, and the present invention is intended to include each such permutation.

### Application Instrumentation Flow of Control

FIG. 5 shows the application instrumentation flow of control, which begins when the instrumentation server receives an original application at step 510, as described above. In the exemplary arrangement illustrated here, the subsequent steps, described in detail below, include analysis of the original application at step 520; acceptance of optional control input from external systems at step 530; and application modification 540.

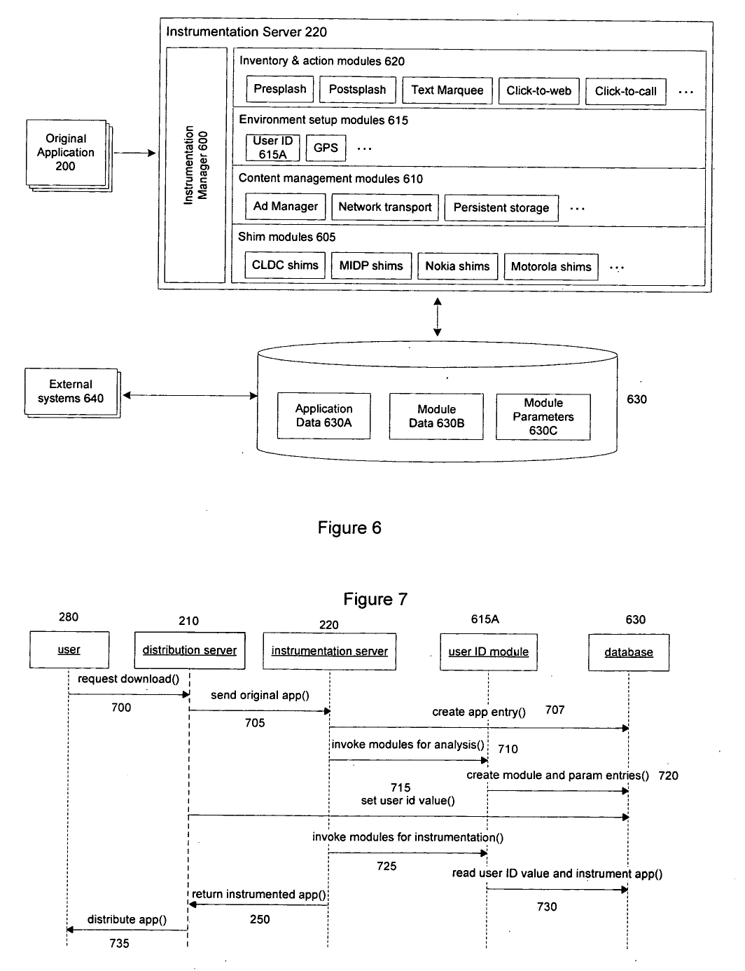

FIG. 6 is a system block diagram of the instrumentation server 220 showing the analysis and rewriting modules and their interaction with a configuration database and optional external systems. An instrumentation manager 600 component accepts an original application 200 and invokes a set of extensible modules, each of which can perform either or both analysis and instrumentation functions.

For the example illustrated in the Figures, the analysis and instrumentation modules are categorized as follows. “Shim” modules 605 provide a layer on top of existing platform APIs and allow the instrumentation code to intercept platform API usage as called for by the original application. Typically, but not necessarily, there is a shim module for each distinct set of platform APIs; for example, in one embodiment there is a shim module for each of the J2ME CLDC and MIDP API sets as well as shim modules for each of the vendor-specific UI APIs, such as those provided by Nokia, Motorola and other vendors of cellular telephones or similar wireless devices. Content management modules 610 provide infrastructure for transferring content between a mobile device and a network server and for managing storage of that content on the mobile device. The device-resident storage is typically a persistent storage mechanism such as FLASH memory or local disk drive and is accessed via file or record oriented platform APIs. Examples of typical content management modules include: an Ad Manager module, which coordinates reception of advertisement content from and transmission of usage data to the network server; a Network Transport module, which provides an abstraction layer to the Ad Manager module on top of the network transport mechanisms available on the mobile device, such HTTP, WAP, raw TCP, and SMS; and a Persistent Storage module, which provides an abstraction layer to the Ad Manager module on top of the persistent storage mechanisms available on the mobile device, such as J2ME RMS (Record Management System) and JSR-75 File Connection. Environment setup modules 615 provide access to environmental information, such as user identification and GPS location. Other modules can use information provided by the environment modules to influence their behavior; for example, the Ad Manager module can use GPS location information to request location-specific advertising content from the network server. Inventory modules provide logic for presenting content at specific locations within an application, such as Presplash, Postsplash and Text Marquee. Action modules 620 provide logic for executing some set of actions in response to user input related to an inventory placement, for example Click-to-Web and Click-to-Call.

The modules described above are typical examples, but other modules are also possible, including but not limited to the following: Content management modules can be provided for managing other types of content, such as billing and subscription data, market research data, personalization data, and networked game data. Inventory modules can be provided for rendering images at other locations within an application, such as during screen transitions. Inventory modules can also be provided for rendering video or audio content. The presentation of any form of content—including visual, audio, and tactile as well as manipulation of any advertising output elements described previously—is generally herein referred to as rendering. Action modules can be provided for accepting survey input and transmitting resulting survey data to a network server. Action modules can also be provided for sending an SMS/MMS in response to user action (“click-to-SMS”). Environment modules can be provided to obtain cell ID information to provide coarse-grained location when GPS is not available. Environment modules can also be provided to detect physical environment conditions, such as ambient light conditions via a device-resident camera or ambient noise levels via the phone microphone. Environment modules can also be provided to obtain the mobile device “profile” setting (which can include “silent”, “normal”, “meeting”, “outdoors”), which can indicate whether use of the device audio output is permitted.

In a typical arrangement, the instrumentation manager invokes modules in order based on their categories, in such a way that later invoked modules can make use of analysis and instrumentation performed by earlier modules. Invocation order can also be defined within a module category. In one embodiment, invocation order is defined by assigning each module category a non-overlapping priority range and by assigning each module an integer priority value within its category's priority range. An example of this layering of module functionality is shown in FIG. 6, where the lower modules are invoked before the modules layered on top of them. Thus, for the example shown in FIG. 6, shim modules 605 are invoked prior to content management modules 610, followed by the environment setup modules 615 and the inventory and action modules 620. Each module typically stores information related to its analysis, for example in a database 630. This module information is shown in FIG. 6 as Module data 630B and Module Parameters 630C. At the start of instrumentation flow 510 for a given application, a record (shown in FIG. 6 as Application Data 630A) is created for the application in the database 630 that serves to organize the Module data 630B and Module Parameters 630C that will be used during analysis and instrumentation of the application. At minimum, the module analysis information 630B includes an indication of whether or not the module is applicable for a given application. For example, when the Motorola shim module is invoked in the context of an application that is designed to operate on a Motorola device (according to the methods explained below), the Motorola module will indicate its applicability by creating a database entry in module data 630B for itself associated with the current application entry 630A. Subsequent modules can query the database for this Motorola shim module entry 630B to determine if they can make use of Motorola APIs when instrumenting the application. When a module creates a corresponding database entry, it can also create a set of database entries representing configurable module parameters 630C. For example, during analysis, the user ID module 615A creates a database entry that represents a configurable parameter 630C, which prior to instrumentation is expected to be populated with the ID of the user for which the application is being instrumented.

Just as higher-level modules can make use of the analysis output of lower-level modules as reflected in the configuration database 630, External Systems 640 can also query and modify the configuration database. One such interaction is shown in the UML sequence diagram of FIG. 7. In this example, the distribution server 210 receives a request at 700 from a specific user 280 for download of an application 200. As described previously, the distribution server 210 will send the original application to the instrumentation server 220, and at 710 the instrumentation server 220 will create an entry in the application database as shown at 707 and will perform the analysis phase by invoking at 710 each module for analysis. After analysis completion, the distribution server 210, as a system that in at least some embodiments is external to the instrumentation server 220, inserts at step 715 the ID of the user that requested the download into the parameter database entries in the database 630 for the user ID module 615A described previously. During the instrumentation phase, the user ID module reads these module parameters at step 730 to retrieve the user ID value and then instruments the application at 725 with code that at runtime will provide the user ID data to the content management modules as shown at 730. After instrumentation, the instrumentation server 220 returns the instrumented application 250 to the distribution server, which distributes the application to the requesting user at shown at 735.

It should be noted that the database 630 and communications paths described above are conceptual descriptions and can be realized by a number of different embodiments. For example, rather than using a database, configuration data can simply be passed by inter-process communication between the instrumentation server and modules and the optional external systems.

The following sections describe the analysis and instrumentation methods in more detail.

Original Application Analysis

An original mobile application is analyzed in order to: identify target application platform and operating environment; identify options for code rewriting; and identify demographic or other ad targeting information.

Object code analysis is performed in general by searching for application entry points and invocations of target platform APIs. Whereas most object code is difficult to interpret, application entry points and use of platform APIs follow well-defined rules. For example, in the case of Java, source code is compiled into a standardized classfile format (and classfiles are packaged together into a JAR file), where the classfile header includes a string table; reference to platform API classes and methods take the form of well-defined instruction bytecodes which identify the target API elements via reference to the header string table. The application entry points in a Java application are implied by a text entry (“MIDlet:”) in the application descriptor JAD file. Applications developed using other technologies (such as Macromedia Flash) in which source code is compiled to an object code format that executes on a virtual machine follow a similar structure; while the object code and application package formats are different, the formats are nonetheless well-defined. Applications developed using technologies which compile directly to machine code (such as native Symbian or BREW applications) rather than to virtual machine bytecodes also follow similar rules: application entry points are identified at well-defined offsets from the start of the object code binary representation, and any reference to platform APIs must reference entries in a symbol table within the object code.

Identification of the target application platform is performed by searching for use of platform APIs. Specifically, certain APIs are supported only on certain platforms. Most mobile platform vendors (such as Nokia, Motorola, etc.) provide APIs which allow applications to use functions specific to their platform. For example, Motorola provides an API class “com.motorola.iden.lcdui.ExternalDisplay”. If an application makes use of this class, then the application is known to execute only on Motorola devices (and more specifically only on a specific class of Motorola devices). Identification of target application platform allows the subsequent code rewriting phase to make use of the target application APIs. Using, for example, the foregoing Motorola API class, the code rewriting phase only has the option of displaying graphics on a secondary cell phone screen via the Motorola API class if the analysis phase determines that the API is supported, based on its identification of the target platform.

Similarly, identification of target operating environment is performed by searching for use of specific APIs. In this case, the APIs can not be specific to vendor or platform but rather incur some user impact. For example, target platform identification can indicate that GPS functions are supported (via the JSR179 API), but the application can or can not make use of those functions; this can be significant in some instances, since use of those functions typically requires explicit user authorization. In this example, identification of operating environment with respect to GPS usage can be determined by searching for use of the API class javax.microedition.location.LocationProvider. If operation environment identification detects that this GPS API is used, then the subsequent code rewriting phase would typically also choose to make use of this API.

Identification of options for code rewriting uses the same techniques. As described in more detail below, conventional code rewriting techniques generally follow one of the following patterns: modification of application entry point(s) as identified in the application descriptor or object code header; replacement of platform API references with references to new code which delegates to the original platform APIs; modification or insertion of code within existing code blocks (i.e., within existing methods or functions). Relevant API references and code insertion locations include but are not limited to the following:

Application entry points. For example, as described previously, Java application entry points are implied by the MIDlet: reference within the JAD file. This reference identifies a classfile in the JAR file, and that classfile must include definitions of the following methods: startApp, pauseApp, destroyApp. These entry points can be replaced, or the code within the methods can be modified in order to perform work (such as display a graphical splash screen) when the application starts, pauses, resumes, or exits.

Application transition points. Example application transition points include invocation or implementation of the javax.microedition.lcdui.MIDlet API methods notifyPaused, notifyDestroyed, resumeRequest, and platformRequest. A further example includes instantiation of the platform API class javax.microedition.lcdui.Canvas and implementation of the Canvas method showNotify; code rewriting can insert code within this method in order to display, for example, interstitial splash screens. A further example includes implementation of the API class javax.microedition.lcdui.CommandListener and its method commandAction, which is an API used to process user menu selections. For example, code can be inserted in this method to detect a game restart condition by analyzing the method arguments and detecting if the menu invoked has a label similar to “New game”; in such cases, code rewriting can insert display code for interstitial splash screens.

Graphical elements that can be interfaced with ad content. For example, references to classes such as javax.microedition.lcdui.Ticker can be replaced with references to a delegating class, where the delegating class displays text advertisements before or after the original ticker contents. Similarly, references to javax.microedition.lcdui.game.Sprite can be replaced with references to a delegating class, where the delegating class displays graphical advertising content in addition to or in place of the original graphical sprite elements.

Other multimedia elements that can be interfaced with ads. For example, the platform API classes javax.microedition.media.Manager and javax.microedition.media.Player are used to control playback of various multimedia types, including audio. References to these API classes can be replaced with references to delegating classes which play multimedia advertisements before or after the original multimedia content.

Access to network services. For example, the API class javax.microedition.io.Connector is used to initiate most network connections. References to this class can be replaced with references to a delegating class which monitors all network traffic for the purpose of collecting advertising targeting data. For example, there are a number of mobile applications which provide weather information retrieved from one of a number of well known web sites (such as www.weather.com). Weather information is typically retrieved by sending a location string, such as a zip code, to the web server. A delegating class can monitor such network traffic for the purpose of determining user location and using that information for ad targeting.

Lastly, information such as demographic indicators can be extracted during code analysis for the purpose of ad targeting. A demographic indicator is any information that narrows the target audience for the application; an example demographic indicator would be text strings within the application code related to sports cars, which would likely indicate that the application users are interested in sports cars. To this end, all text content is extracted from the original application and can be provided to an ad targeting system. Text content can be extracted directly from string constants or can be inferred based on analysis of string concatenation code. Other content, such as graphics and audio, can also be extracted and presented to targeting systems. For example, audio content can be presented to a song recognition service, such as Gracenote Mobile MusicID, where recognized audio content directly implies target demographics. Graphical content can similarly be extracted and analyzed, for example, to extract textual content from images via optical character recognition techniques.

Note that while analysis is typically applied to original applications that have been developed without the intention of submitting the applications to analysis, the analysis can also be applied to applications that have been developed with this analysis in mind. For example, it is described above how the analysis can determine potential opportunities for splash screen insertion based on detecting references to standard platform APIs. The analysis process can also be directed to detect references to non-standard APIs provided by the implementer of the methods of this invention. A developer can make use of such references in order to provide control directives to the instrumentation process. Although these references are inserted during source code development, it is still useful to submit the resulting application to the code instrumentation process for inclusion of additional functionality, such as presentation of static ad content, which cannot generally be provided at source code development time.

### External Control Input

The instrumentation process can optionally accept from external systems additional control input and content, such as user identification and static ad content. In one embodiment, these external systems interface with the instrumentation server via the configuration database, as shown in FIG. 6. In another embodiment, these external systems can interface directly with the instrumentation server via mechanisms such as RPC or web services.

As described previously, in the case of instrumentation during application download, the download server typically knows the identification of the downloading mobile device or user; this user identification can be provided to the instrumentation process so that it can be added to the instrumented application.

Static ad content can also be provided to the instrumentation process for inclusion in the instrumented application. Ad targeting information gathered during analysis, such as demographic information, can be queried by an external system in order to influence the ad content that will be either statically included into the application or served to the application dynamically via a network connection at a later time. For example, a conventional “Ad Network” server (such as those operated by 24/7 Real Media or Experclick) can organize its available advertising content by interest categories (such as sports, finance, music, etc.). As described previously, instrumentation analysis of an application can determine demographic indicators; these demographic indicators can be mapped to these interest categories and used by Ad Network servers in order to provide targeted ads to the application.

### Application Modification

The final step of the instrumentation process is modification of the application based on the results of the preceding analysis and optionally based on external control input. Code rewriting techniques are described in more detail below.

### Code Rewriting Techniques

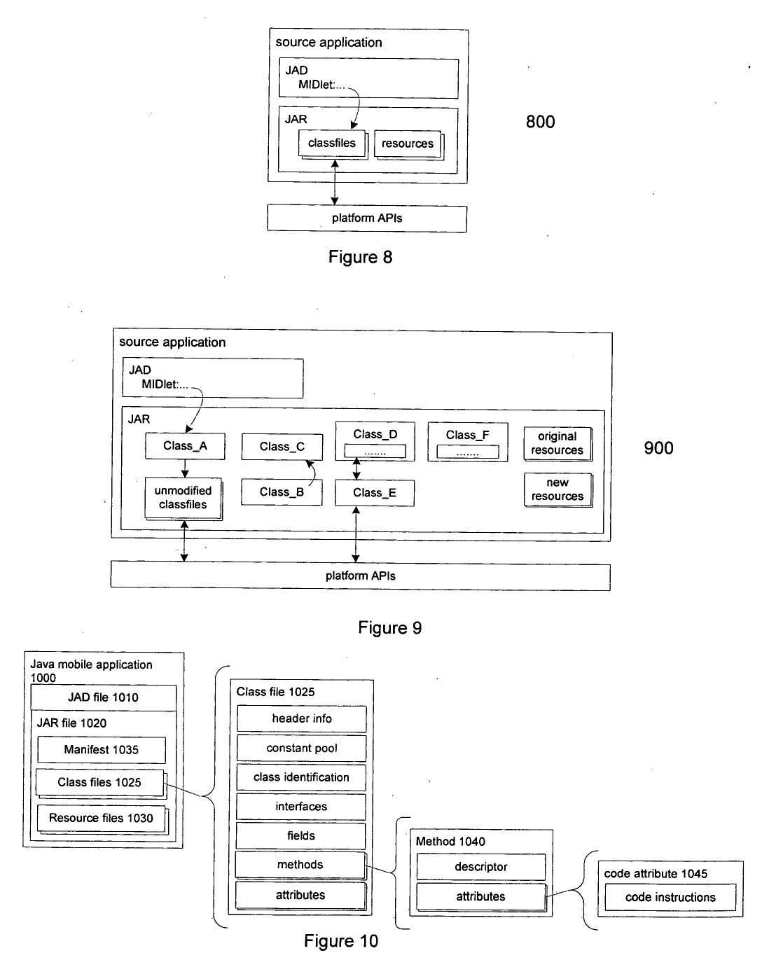

FIG. 8 and FIG. 9 provide a pictorial representation of the effects of instrumentation on a mobile application. FIG. 8 depicts the original application, indicated generally at 800, while FIG. 9 depicts various forms of instrumentation, indicated generally at 900. The actual modifications are performed on the binary representation of the application, as outlined below. The following descriptions are made in reference to a Java application but have corresponding analogies for applications developed using other technologies such as Flash, Symbian/C++, or BREW/C++, as noted above.

The complete format of Java object code is well-documented in the prior art, but FIG. 10 shows the most relevant components. As shown in the figure, a Java mobile application 1000 comprises an application descriptor text file, called a JAD file 1010, and an application binary image, called a JAR file 1020. The JAD file describes to the Java virtual machine and runtime environment how to execute the contents of the JAR file. A JAR file is essentially a compressed archive of files using the ZIP compression format. The contents of a JAR file includes class files 1025 (also known as “classfiles”) and resource files 1030 as well as a manifest 1035, which describes the JAR file contents. A resource file can be encoded in any compatible format. A classfile 1025 encodes a Java class in compiled form and has a well-defined format comprising: header information, a constant pool (similar to a string or symbol table), class identification information, a list of interfaces implemented, a list of class fields, a list of methods, and a list of additional attributes. Of primary interest are the methods 1040, which further decompose into descriptor information and additional attributes, where one type of attribute is a code attribute 1045. The code attribute ultimately contains the compiled virtual machine instructions (byte codes), which are the primary target of modification during application instrumentation. Throughout the remaining discussion, these various classfile components are referred to by their formal designations defined in the Java virtual machine specification.

### Application Entry Point Modification

As described previously, the entry point for a Java mobile application is indicated in a text JAD file via the entry labeled MIDlet:. This identifies a classfile by name within the JAR file. The application entry point can be modified by simply changing the JAD file MIDlet: entry to reference a different classfile within the JAR. Typically, the newly referenced classfile is a new classfile not existing in the original application. FIG. 9 depicts modification of the JAD file to reference a new class Class_A which delegates to the original application entry point.

### Reference Replacement

As described previously, the code analysis and modification procedures can be performed in the context of references to platform APIs. Such references include class instantiation, class derivation, interface implementation, field reference, and method invocation. These references can identified as follows: Instantiation of a specific API class can be found by scanning the bytecodes of each method in each classfile and searching for the bytecodes corresponding to the new instruction, where the instruction operand references a corresponding classfile constant_pool string (by way of a separate CONSTANT_Class entry) that is the internal form of the name of the API class of interest. Direct derivation of a class from a specific API class can be found by inspecting the super_class field of each classfile and checking if the field references a corresponding classfile constant_pool string (by way of a separate CONSTANT_Class entry) that is the internal form of the name of the API class of interest; indirect derivation can be identified by recursively applying the foregoing procedure to the identified superclass. Implementation of a specific API interface can be found by inspecting the interfaces field of each classfile and checking if the field contains a reference to a corresponding classfile constant_pool string (by way of a separate CONSTANT_Class entry) that is the internal form of the name of the API interface of interest. Reference to a specific API class field or method can be found by scanning the bytecodes of each method in each classfile and searching for the bytecodes corresponding to a field access instruction (getfield, getstatic) or a method invocation instruction (invokevirtual, invokestatic, invokeinterface) where the operand references corresponding classfile constant_pool strings (by way of a separate CONSTANT_Fieldref, CONSTANT_Methodref, or CONSTANT_InterfaceMethodref entries) that identify the internal form of the name of the API class of interest and the name of the API field or method of interest.

Modifying any of the foregoing references amounts to modifying the index into the corresponding classfile constant_pool. Typically, the new reference involves a new class not existing in the original application, in which case the new entries to be referenced must first be added to the classfile constant_pool. FIG. 9 depicts modification of a superclass reference where original application class Class_B is changed to refer to new class Class_C. The diagram depicts modification of API field and method references, where original application class Class_D is modified to refer to new class Class_E, which delegates to the original platform APIs.

### Code Insertion

A new classfile can be added to a mobile application simply by adding the classfile to the application JAR. In order to add code to an existing classfile, the appropriate code insertion point must first be identified. New code insertion points can be categorized as: before or after reference to an API element; or at the beginning or end of an overriding API method implementation. Identification of API element reference locations is described above. An API method implementation can be found by first identifying classfiles corresponding to subclasses of the API class of interest and then searching those classfiles for implementation of the API methods of interest. Identification of derivation from an API class is described above. API method implementation within a classfile of interest can be identified by searching each entry in the methods field of the classfile and checking for entries that reference a constant_pool string that matches the internal form of the name of the API method of interest.

Once a code insertion point is chosen, new bytecodes can simply be inserted into the existing method bytecodes. After insertion of new bytecodes, any reference to pre-existing bytecode offsets that follow the new bytecodes must be updated. For example, pre-existing goto instructions which occur before the new bytecodes but reference a branch offset after the new bytecodes will need to be updated to reflect the changed branch offset. FIG. 9 depicts insertion of new code into original application class Class_F.

### Resource Files

New resource files, including binary data such as images and audio clips, can simply be added to the application JAR file, as depicted in FIG. 9. Text information can also be added as new entries in the JAD file and accessed as text resources via standard platform APIs.

### Minimizing Code Size Expansion

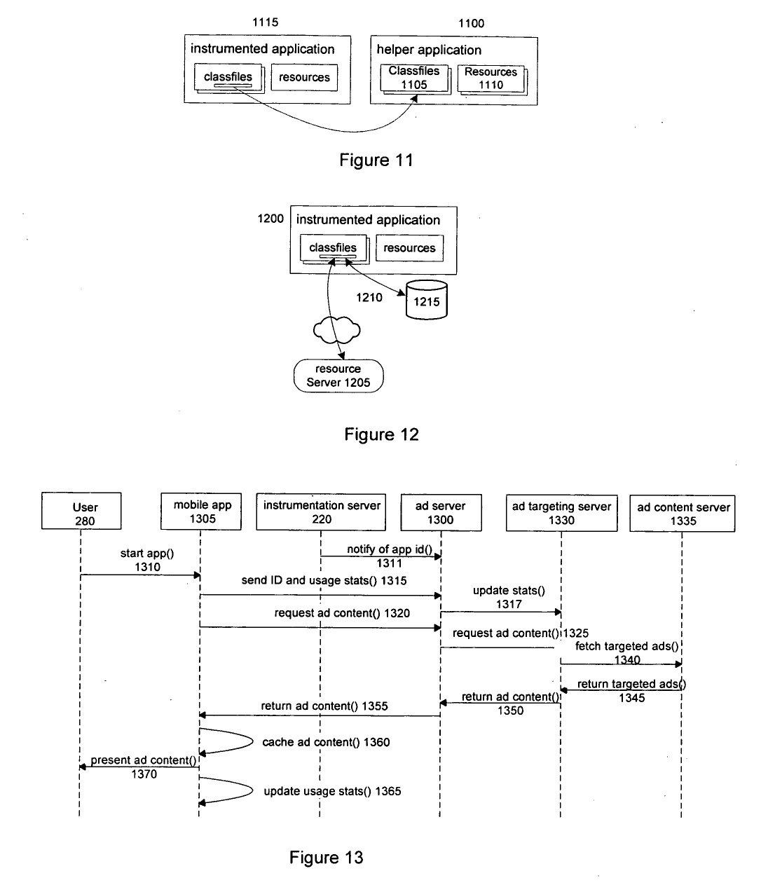

Since most of the application modifications described above involves addition of new code, classfiles, or resources, the resulting application JAR will increase in size. This can be unacceptable for certain devices, since some mobile device platforms impose maximum JAR size constraints. FIG. 11 and FIG. 12 depict two techniques for minimizing the effects of instrumentation on JAR size

FIG. 11 depicts use of a separate helper application 1100, where: some of the instrumentation code and/or some of the original application code is packaged in the helper application as shown at 1105 and 1110, respectively; and the application 1115 is instrumented to communicate with the helper application via some form of IPC, such as a loopback network socket or shared persistent storage. For example, a typical application includes a startup splash screen that consumes a significant portion of the allowable JAR size; this splash screen (code and resource) can be moved to the helper application, and the instrumented application and helper application can coordinate via IPC at startup time in order to display the splash screen.

FIG. 12 depicts an alternative approach that includes removal of some resource files from the JAR of the instrumented application 1200; insertion of new code to retrieve the removed resource files from a network-accessible resource server 1205; insertion of new code at 1210 to persist the retrieved content in local storage 1215 for later usage. Note that while mobile device platforms typically limit the amount of persistent storage space available to each application, most applications use much less persistent storage space than is allowed.

### Runtime System Interactions

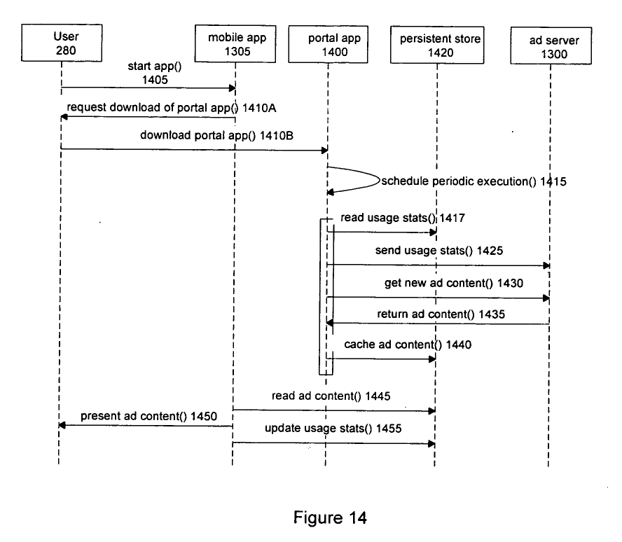

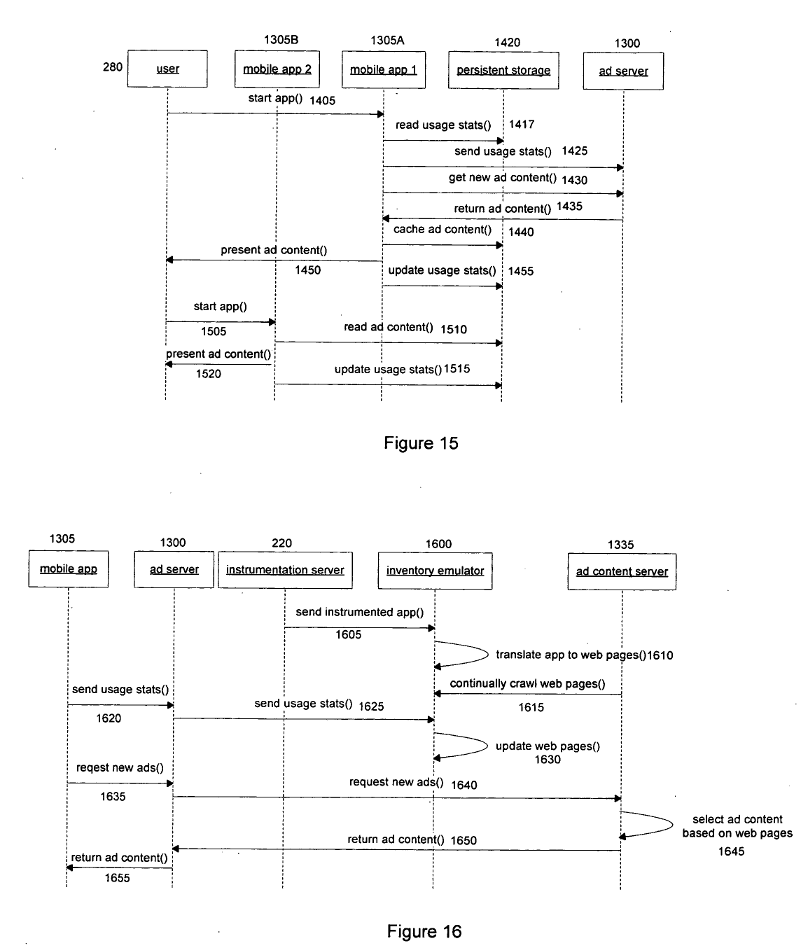

An instrumented mobile application can be non-network enabled, in which case all required advertising content is inserted into the application at instrumentation time. More typically, an instrumented mobile application will be network enabled in order to acquire new advertising content over time. FIG. 13, FIG. 14 and FIG. 15 show examples of how an instrumented application can communicate with other system components in order to acquire new advertising content.

FIG. 13 shows an instrumented application communicating directly with an ad server. After application instrumentation but prior to first application execution, the instrumentation server 220 notifies the ad targeting server 1330 at 1311 of the identity of the instrumented application 1305, which can be specific to a single mobile device or user or can address a group of devices or users. After initial application launch at 1310, the instrumented application typically communicates periodically with the ad server 1300. The frequency typically depends upon a combination of time (including elapsed time, specific time, and periodic schedule) and ad viewing statistics; for example, the application can contact the ad server once it has shown its current ad content some fixed number of times, or it can contact the ad server 1300 immediately in response to user interaction with ad content (for example, to fulfill a user request for subscription to services advertised). This communication can include the application sending its identification to the ad server along with any usage statistics gathered since the previous ad server communication as shown at 1315. The ad server 1300 passes this identification and usage information to the ad targeting server 1330 as shown at 1317. The communication can also include the application sending a request for new ad content to the ad server as shown at 1320; included in this request can be information related to the current mobile device operational environment, such as location. The ad server 1300 sends this request to the ad targeting server 1330, which requests and receives ad content from the ad content server 1335 as shown at 1340 and 1345, respectively. The ad targeting server 1330 returns the ad content to the ad server 1300 as shown at 1350, and the ad server returns the content to the application as indicated at 1355. The ad content can include meta-data such as the following: CPM (cost per mille impressions), CPA (cost per action), ad priority or desired sequencing relative to other ads, desired inventory placements, desired impressions frequency, desired maximum impressions, desired duration of each impression, desired impressions times and geographic locations, and expiration date. In some arrangements, the application stores the ad content and associated meta-data in persistent storage on the mobile device for future use as indicated at 1360. The application renders the ad content in the instrumented inventory locations according to any constraints indicated by the ad content meta-data. Finally, as indicated at 1365, the application updates application usage and ad interaction statistics in persistent storage. The ad content is presented to the user as shown at 1370.

The application can piggyback on user accesses of the internet, and only use those opportunities to update or replace ads. This can avoid unwanted airtime charges to a user. The user might access the internet for web browsing, to contact another player for a game, etc. The updates could involve removing an ad to save memory space, such as by uploading part or all of the application, modifying it, and re-downloading it.

Execution of application code that implements the server communications, including processing of any data received from the server, can occur simultaneously with execution of original application code. For example, retrieval of ad content can execute on a separate thread of execution that does not interact with the mobile device user interface, such that the end user can interact with the original application behavior without waiting for the ad content retrieval to complete.

FIG. 14 shows an example of an instrumented application communicating with an ad server via portal application 1400. On initial application launch 1405, the application 1305 detects if the portal application 1400 has been installed yet. If the portal application has not been installed, then at 1410A-B the application initiates user download of the portal application. When the portal application is first downloaded, it schedules itself for automatic periodic execution as indicated at 1415. Each time the portal application is executed, as shown at 1417, it checks in persistent storage 1420 whether there are any application usage statistics to be sent to the ad server as well as whether new ad content is needed. If either is true, the portal application communicates with the ad server in a manner similar to that described in FIG. 13, as shown at 1425 and 1430. After acquiring new ad content as indicated at 1435, then at 1440 the portal app stores the ad content in persistent storage that is accessible to the instrumented application. When the instrumented application executes, indicated at 1445, it reads ad content from the shared persistent storage, renders the ad content as appropriate at 1450, and updates usage and ad interaction statistics in persistent storage at 1455.

FIG. 15 is similar to FIG. 14, except that two or more instrumented applications are installed on the same mobile device, and one of the applications performs the functions of the portal application. The choice of which application performs the portal functions can depend on which application executes first within a given time period. Alternatively, the choice can depend on which applications accesses the network first within a given time period. Alternatively, the choice can depend on some notion of application priority; for example, the application with the greatest amount of ad functionality instrumentation can have the highest priority. In the example of FIG. 15, application 1, indicated at 1305A, starts first as shown at 1405 and performs the functions of the portal application. Application 2, indicated at 1305B, starts later as shown at 1505 and reads ad content from and stores usage statistics to persistent storage on the mobile device as shown at steps 1510-1515, and relies on application 1 to communicate this data to the ad server. Mobile app 2 presents its ad content at the appropriate time to the user as indicated at step 1520.

### Advertising Targeting

Effective ad targeting is an important function, since poorly targeted ads annoy users and decrease application usage. Ad targeting depends on collection of user demographic and contextual information. A number of techniques are outlined above for acquiring such information, including: acquisition of user identity during download process; analysis of static application content such as text and multimedia content; analysis of network usage at runtime; tracking usage location based on GPS. Additional techniques are outlined below.

It is generally not permissible by advertising industry standard practices to transmit or store any user-related information in such a way that the user identity can be determined from that information; such information (such as phone number, direct connect number, device email address, or device serial numbers) is conventionally referred to as Personally Identifying Information (PII). To avoid the use of PII, instrumented applications for at least some embodiments of the present invention do not store user identity as determined either during the download process or via use of platform APIs. Rather, in such embodiments a one-way hash of the PII is generated using well known techniques such as MD5 or SHA-1. This PII hash is stored by and communicated between the instrumented application and the ad server. The carrier and typically the application distributor also know the PII as well as other user demographic information. This demographic information can include for example location of residence, age, income level, gender, race, nationality, education level, consumer preferences, spending patterns, marital status, family size, languages spoken, health factors, and bodily characteristics. This demographic information can be obtained directly or indirectly from the end user, or it can be inferred from other demographic data determined for example at the time of application analysis or instrumentation. In order to request demographic information from the carrier or distributor without transmission of PII, the PII hash can be used.

An alternative technique that allows the ad server to determine PII related to a mobile application is for the mobile application to send a text message to the ad server. The text message source address includes PII in the form of the originating mobile device phone number. After receiving the PII, the ad server translates it to a PII hash for use in subsequent interactions.

Identification of a users' carrier implies a certain demographic. Carrier identity is typically known at application download time. An instrumented application can also communicate its carrier identity by sending a text message to an email address monitored by the ad server; the text message will be sent as an email, and the source address domain will identify the carrier.

As noted previously, some mobile web browsers include cell ID and other contextual information in the header of HTTP or WAP requests; this information can not otherwise be generally accessible to applications. An instrumented application can communicate this information to the ad server by invoking platform APIs to launch the web browser and request a page from a web server monitored by the ad server.

FIG. 16 is a diagram showing previously described functionality of the inventory emulator application interacting with an ad content server, such as Google AdSense. The instrumentation server 220 provides an instrumented application to the inventory emulator 1600 as indicated at 1605, which translates a representative portion of the application to web pages at 1610. This translation can include rendering the mobile device display as a sequence of static images with interleaved text, where the text is extracted as described previously from the original application. Any additional demographic information determined during original application code analysis can also be included in the web pages. The ad content server 1335 periodically crawls the inventory emulator's web pages and builds up ad relevancy information for those pages as indicated at 1615. When the instrumented application (executing on the mobile device) sends usage and contextual information to the ad server as described previously and as indicated at 1620, the ad server 1300 sends that information to the inventory emulator 1600, which can augment the web pages with the new information as indicated at 1630. When the instrumented application sends a request for new ad content to the ad server as shown at 1635, the ad server forwards the request to the ad content server 1335 as indicated at 1640. As indicated at 1645, the ad content server selects ad content based on the previously determined ad relevancy information and returns it to the ad server at 1650, which returns the content to the instrumented application at 1655.

### Ad Selection

In contrast to existing web advertising systems, the mobile advertising system of this invention can detect and make use of the differences in display and general capabilities of devices to which the system serves ads. The present invention is capable of distinguishing between ads and creatives, similar to online web ad systems, which can aid in the organization of creatives based on ad message or other criteria. However, this system of the present invention expands upon the traditional distinction between ad and creative and allows creatives within an ad collection to have different display characteristics (such as image size and color depth) as well as different associated actions. The ad system of the present invention can, in at least some embodiments, select ads based on ad targeting objectives as described above but selects creatives from within an ad collection based on the capabilities of the device environment to which the ad is to be served. These capabilities criteria can include any characteristic of the target device environment that is available to the application into which the ad is to be served; these capabilities can include but are not limited to: screen size and color depth; number and type of screens, including internal and external (with respect to clamshell devices); device model; available storage; location capabilities such as GPS; media input capabilities (audio, still image, and video); media playback capabilities (audio and video); web browsing capabilities; processor speed; network transport capabilities (such as TCP vs WAP) and speed (bandwidth and latency); character input mechanisms and modes (such as QWERTY vs multi-tap vs T9 vs sylus-based); touch screen input; contactless identification and payment mechanisms such as RFID; Bluetooth capabilities; light sensors.

This arrangement of ads and creatives is particularly significant in mobile ad systems in which client applications can cache multiple ads and creatives, but one creative is better optimized to the characteristics of a particular device. Consider the situation where clients cache multiple ads, where there is no relationship among creatives that takes into account creative image dimensions, and where there are two creatives that have exactly the same image except that the dimensions are different. If the ad server simply serves ads based on what the client is capable of rendering, then the server may serve both creatives to a single client, and the client may present those creatives in succession. This is not ideal, not only because presentation of the second creative is redundant and dilutes the advertising impact, but also because the change in dimensions may appear to the viewer as a defective ad, and thus create a negative impression. With the solution of this invention, the ad server chooses the creative within an ad collection that is best suited for presentation on the device to which the ad is to be served.

Note that the system of this invention supports but does not require the distinction between ads and creatives. In the absence of this distinction, an ad is effectively the same as a creative, and the selection process described above for creatives applies equally to ads.

### Ad Targeting in the Presence of Caching

In online ad serving, ad impressions are recorded at the time that they are served. Since online ad servers record impressions at the time of ad serving, those servers can target ads deterministically based on the known history of ad impressions. As described above, the mobile ad system of this invention can allow clients to cache ads and can receive ad impression reports at a later time. Because this mobile ad system can serve an ad without knowing the exact number of impressions for that ad to date, in some embodiments the ad system of the present invention can target ads statistically rather than deterministically. In other words, this system selects ads based on an estimate of how many impressions have occurred, rather than how many impressions are known to have occurred.

Such an approach can, in some embodiments, have significant benefits. Because this mobile ad system can target ads based on statistical projections, it can also operate in the absence of client impression reports. In other words, based on serving and impression statistics, the present system can accurately target ads even if a subset of clients does not report statistics. Non-reporting can occur in two cases: 1) impression statistics have been recorded on the client device, but the client application has not subsequently been executed again in order to cause those statistics to be sent to the server; 2) the server explicitly instructs a client not to report statistics (either for some duration of time or forever). The latter case is significant in that it reduces client processing as well as the amount of additional code that is added to the original client application.

### Portal Application

In one embodiment, the code rewriting inserts code that communicates via IPC with a portal app on same device. The IPC is via one of persistent store or a loopback network. The portal application can communicates with the network. The portal application launches periodically based on timer to communicate with server. Alternately, an instrumented application can cause the portal application to launch and perform its work. The launch can be caused by a push registry based on loopback traffic. The portal application can write a healthy flag, optionally timestamped, to persistent store. Optionally, if an application is unable to launch the portal application, it shuts down or uses cached ads. Alternately, if an application detects that the portal application has not launched within a time requirement, it shuts down or uses cached ads.

### Cooperating Applications

The code rewriting can insert code that writes to commonly accessible persistent store its existence and its usage and ad presentation statistics. The code rewriting can insert code that writes ads fetched from an ad server to commonly accessible persistent store. The inserted code can detect the presence of other instrumented applications. The instrumented applications can coordinate such that only one application sends statistics for all applications to the ad server and fetches ads for all applications. Where instrumented applications coordinate by way of time, the first application to execute within a fixed time period is the only application within that time period to access the network. Alternately, where instrumented applications coordinate by way of application priority, the application with the highest priority contacts the server. The priority can be based on whether and application has code other than instrumented code that accesses network.

### Identifying the User

A PII hash can be inserted at the time of code rewriting. Alternately, a PII hash can be generated at runtime. The PII hash can be generated by a carrier (or distributor) (who has user and/or device IDs). Where mapping from PII hash to PII is not stored by the carrier for security purposes, but where the PII hash is mapped to demographic information, the mapping can be provided to an ad targeting/demographic tracking system. The UID could be not stored in the application, but rather the ad system can determine the PII via application communications. The application can contact an ad system via SMS and the ad system can extract a source address to use as PII, then use a PII hash to communicate with the targeting system. Demographic information can be extracted by monitoring the SMS system. By using an sms gateway; when we receive an sms, we know the user's carrier based on source sms gateway based on lookup of its ss7 address. We can assign to the user the average demographic information for that carrier (ie, some carriers have users that are older, younger, businesses, family, etc).

The UID can be made available to an advertising system. Demographic information can be made available, based on UID lookup, to the advertising system. The demographic information gathered by other means can be added to the demographic system. The demographic information can be based on one of location, application usage, survey response, purchase action via mobile, etc. The demographic information can be based on information extracted from application object code prior to instrumentation, where information extracted includes string information. The demographic information can be based on network data sent and received by an application (eg search terms, weather zip code, stock tickers). The ad targeting system and demographic collection system can be either the same system or are separate systems. The UID can be used for ad targeting.

### Actions Associated with Advertising Content

In web-based advertising, there is a well established mechanism for interacting with basic advertising content: the advertising text or image is (or is enclosed in) a hyperlink, so that the user simply clicks on the link to view additional information related to the advertisement. This click-through is conventionally known as an advertising action. When advertising content is added to a mobile application, the same actions do not necessarily apply, since the advertisement is rendered in an arbitrary application and generally not in a web browser. This difference results in a need for a different action mechanism for advertising content in mobile applications.

One technique is to use the “command key” support built into most mobile application development platforms. For example, in Java J2ME, this refers to the class javax.microedition.lcdui.Command. The precise functionality of this command key mechanism varies depending on mobile device type, but a command key mechanism is typically mapped to one of the generic device buttons (also known as “function keys”). Multiple commands can be mapped to the same physical button, in which case the mobile device typically displays a menu containing the multiple commands when the button is selected.

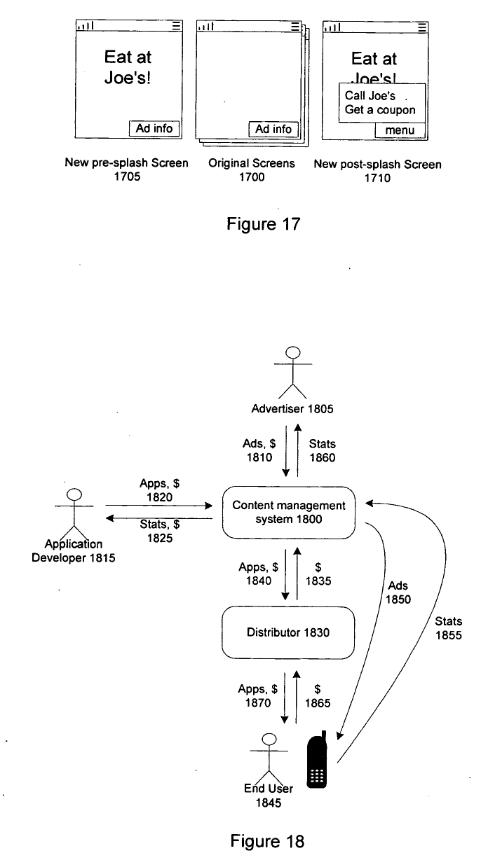

FIG. 17 depicts an example application whose original screens 1700 are augmented with pre-splash screens 1705 and post-splash screens 1710. In the pre-splash screen 1705, a single command (indicated by the “Ad info” menu label in the lower-right of the screen) has been registered in conjunction with the advertising content. When the user presses the associated function key, some action would result; as an example, the device web-browser could be launched and opened to the advertiser's web page.

Because the advertising action is associated with a function key which is independent of the advertising content, the function key command and associated advertising action (indicated by “Ad info”) can continue to be displayed in the original application screens even after the advertising content is no longer displayed. This is significantly different than web-based advertisements and is depicted in the middle set of screens in FIG. 17. Note that other commands could also be displayed in the original application; for example, a command could be displayed to recall (re-display) the original splash screen advertisement.

The last screen depicted in FIG. 17, screen 1710, shows how two actions can be associated with the same advertising content; in this example, the first action (“Call Joe's”) initiates a phone call to the advertiser, and the second action (“Get a coupon”) downloads a coupon to the mobile device. This ability to associate multiple advertising actions with a single advertising content is an additional aspect of some embodiments of the present invention.

While the above sections describe use of function keys to initiate actions (or, more generally, interact with ads), other input mechanisms described earlier may also be used. These include, for example, monitoring of tilt sensors, accelerometers, GPS location, and RFID status.

### Commercial Application

A primary factor in advertising-supported businesses is audience reach, meaning the number of people that will experience the advertisement. Mobile applications have not traditionally been appropriate for monetization via advertisements, because most mobile applications have thousands rather than millions of users. Typically, even a single advertising campaign (let alone an advertising industry) requires reach of tens of thousands users. While few individual mobile applications have the user base required to support monetization via advertising, a large number of mobile applications in aggregate can attain the required reach. However, there is a “chicken-and-egg” issue in that it is difficult to gain a large number of users across a larger number of applications without having some approach to monetization before the reach is attained. Typically, creating a large number of mobile applications and acquiring a large user base both cost significant money, and that cost has traditionally been recouped via charging users for application usage.

The present invention solves the chicken-and-egg problem by providing a mechanism whereby a large number of pre-existing applications (for which the development costs may already have largely been recouped) can quickly be retrofitted to support delivery and tracking of advertisements. Specifically, the automation provided by this invention is critical in order to quickly grow the user reach required to support an advertising-supported ecosystem. One example of the financial details of this advertising-supported ecosystem is described below and illustrated in FIG. 18.

In FIG. 18, the “content management system” 1800 refers to the system of this invention. In the most common scenario, the advertiser 1805 agrees to pay a certain amount for each ad shown via the system, indicated at 1810. The application developer 1815 agrees to provide applications to the system 1800, as indicated at 1820, in return for a share of the ad revenue that will be generated by his applications, indicated at 1825. The distributor 1830 agrees to distribute applications from the system, indicated at 1835, in return for a share of the ad revenue that will be generated by the applications he distributes, indicated at 1840. The end user 1845 downloads applications from the distributor to his phone at 1850, typically although not necessarily without paying any money to the distributor. When the user executes the application, the application communicates with the system, receives ads, and reports ad viewing statistics, indicated at 1855. The system collects statistics, bills the advertisers accordingly at 1860, and pays the distributor and developer based on the prior agreements. Variations on and additional details of this basic environment are outlined below.

The advertiser, which may act via intermediaries such as advertising agencies, injects money and advertisements into the system. The money may be paid in a number of possible arrangements, including any combination of: system usage fees (also known as “ad serving” fees), per ad impression fees (also referred to as “CPM” or cost per thousand impressions), and per action fees for actions associated with ads (also referred to as “CPC” or cost per click). The money may be paid in advance or after some number of impressions or actions have been realized (or any combination thereof). When money is paid in a CPM or CPC arrangement, impression and action statistics are typically provided by the system to the advertiser. These statistics may be directly measured by the application when impressions and actions are realized, or the statistics may be estimated based on a statistical approach such as sampling. When ads are injected into the system, they may be qualified by additional targeting information as described earlier, and the cost for servicing ads may vary based on this targeting.

The application developer, which may act via intermediaries such as licensors of their content, inject mobile applications and possibly money into the system. The money, if involved, may be paid for a combination of system usage fees (measured per-application or per end-user) and fees for statistics generated by the system. Money is also paid from the system to the application developer. This may be any combination of: one-time, per-user, or per-use fees for licensing the use of the application in the system; a revenue share percentage of advertising revenue generated by use of the application; or a prepay on advertising revenue. Money paid to the developer may vary based on usage of the application, for example based on how the application is distributed or based on demographic information associated with the application's end users. Statistics related to application usage and ads/actions delivered through the application may be provided by the system to the developer.

The distributor box in FIG. 18 may represent a single entity or a chain or network of distribution entities. In any case, the distributor receives mobile applications from the system and provides these applications to end users. In some arrangements, the distributor may pay for usage of the system. The application as provided to the end user through the distributor may be modified to incorporate identification of the distributor, so that application usage may be associated with the distribution path through which the game was downloaded. In return for distributing applications, the distributor may be paid either a fixed or variable fee that that may be dependent on the advertising revenues obtained via the applications it has distributed.

End users download applications from distributors and execute the applications on their mobile devices. In some arrangements, the end user may pay for usage of the system or of downloaded applications, but this cost is typically less than the cost of downloading the applications without advertising support. When the applications are executed, the application displays advertisements that are either bundled with the application or obtained via communication with the system. Application usage, ad viewing, and ad action statistics may also be provided by the application during execution to the system. In some arrangements, application usage may be limited based on the amount of ads viewed or ad actions taken. In some arrangements, end users may be paid based on their ad and action statistics.

Many permutations of the above may be combined into viable business models. For example, in a “single sponsor” environment, a single advertiser may pre-pay a fixed amount for exclusive delivery of its ads into a limited set of games to be downloaded some maximum number of times from a single distribution point. As another example, a publisher may act as the distributor for its own games and rely on a peer-to-peer file sharing network to distribute its games to end users.

### Additional Uses of the Invention

Although the preceding description focuses on use of the invention for the purpose of mobile advertising, the core invention is independent of the type of data that is distributed to and retrieved from a mobile application. The core invention is also independent of the specific logic that is added to a mobile application to coordinate the new data distribution and retrieval. Other example uses of the invention are described below.

### Billing and Subscription Management

Billing and subscription management for mobile applications are typically enabled via source code integration with code libraries that are provided by the carrier or distributor through which the application is to be sold. Different distribution channels can require integration with different billing and subscription management libraries. The integration effort required to use these libraries presents a hurdle that some developers are not willing or able to overcome. If the integration with these libraries could be accomplished automatically at some point after completion of application development, this could enable more developers to take advantage of billing and subscription services.

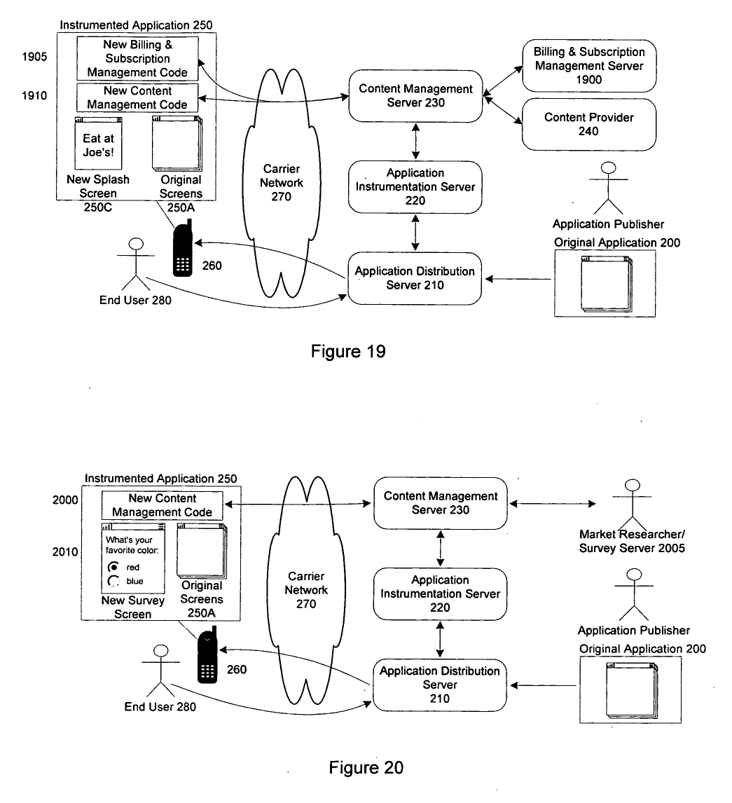

The present invention can be used to perform this automatic integration with billing and subscription libraries, as depicted in FIG. 19. It should be noted that this figure is essentially the same as FIG. 2 with the addition of a billing and subscription management server 1900 as well as slight changes to the instrumentation steps. The instrumentation process for this usage includes two additional steps: 1) add the billing and subscription code libraries 1905 to the application package; and 2) add new instructions at each application entry point to invoke the appropriate functions in the new code libraries. Certain billing and subscription APIs can require an application identifier and/or a user identifier, both of which can be provided to the instrumentation process via the same mechanisms described previously.

The present invention can also be used to enable support for application trial periods, which are periods of time after application download that applications can be used without billing (i.e., for free). To enable this, the instrumentation process adds code at the application entry points to check the current date and/or time prior to invoking the billing and subscription APIs. The previously described methods can also be used to distribute advertisements into the applications for presentation during the trial periods, allowing the developer to begin monetizing an application prior to the start of billing.

### Market Research

The present invention can be used for both passive and active collection of market research data.

The preceding describes use of the invention to insert code into a pre-existing mobile application for the purpose of reporting advertising statistics to a server. Passively monitored statistics surrounding mobile application and device usage are also useful for general market research. Collection and correlation of information such as the following is of interest to mobile market researchers: cellular carrier, overall voice and data usage, time and duration of voice/data usage, volume and frequency of text and multimedia messaging usage, number and type of application downloads, time and duration of application usage. Existing mobile market research firms (such as M:Metrics, Telephia, and NPD) gather this market data using a combination of traditional user surveys and specially instrumented mobile devices. Similar to the current art in mobile advertising, the devices used for mobile market research are custom developed by the research firm for the purpose of usage monitoring. Because the devices are specially instrumented, they are only distributed to a small sample group (typically tens of thousands of people). A larger sample group can increase statistical confidence.

The present invention can be used to instrument applications after development for the purpose of passively collecting such statistics as described above. Some statistics can be monitored directly, such as time and duration of application usage for the instrumented application itself. The remaining information listed above (carrier, voice/data/messaging usage, other application downloads) can be collected via platform APIs on certain devices. For example, on certain Motorola devices the com.motorola.iden.recentcalls.RecentCalls class provides access to recent voice usage. Similarly, on certain RIM BlackBerry devices, the net.rim.blackberry.api.phone.phonelogs.PhoneLogs class provides access to recent voice usage. As described previously, the analysis phase of the instrumentation process is responsible for determining the target platform capabilities, which in turn determines how the various statistics are to be gathered. After collection, the statistics can be stored and periodically uploaded to a statistics collection server in a similar manner to which advertising statistics can be uploaded to an advertising server.

The prior description of advertising content included interactive content such as customer surveys. Surveys are also a useful tool for market researchers, and the same mechanisms of the present invention described previously can be used, as depicted in FIG. 20. An application can be instrumented after development by implementing new management code 2000 to: accept distribution of survey questions from a survey server 2005; present the survey questions to the user at some point during application execution, such as startup or shutdown and accept user input in response to the survey questions as indicated at 2010; and, in at least some embodiments, optionally store the user responses locally for some period of time; and finally transmit the user responses back to the survey server 2005, for example, through communication with the content management server 230, although such retransmission is not required in all embodiments and any suitable communication mechanism is acceptable.

### Personalization

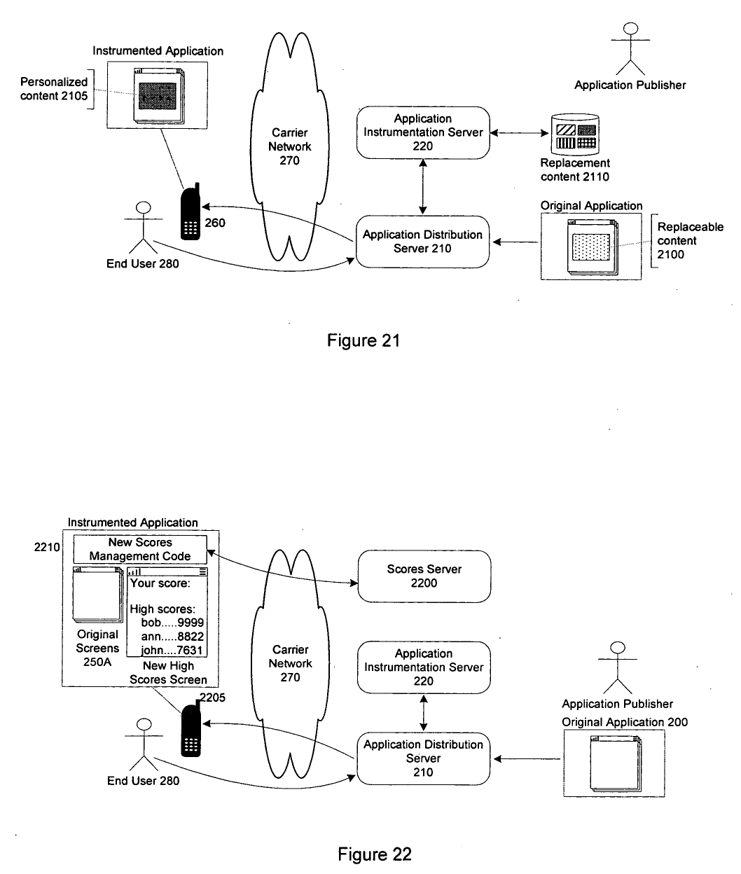

Many products exist that allow a user to personalize a mobile device. These products include ring tones, wallpapers, and device face plates. The present invention can be used to allow a user to further personalize a mobile device by personalizing the applications that are downloaded to the device. For example, an end user can wish to download a sports game to his/her mobile device and might furthermore wish to personalize that game with graphics and audio content associated with, for example, his/her favorite sports team. In the simplest form, this personalization instrumentation can include allowing the user to select from a list of images (similar to wallpapers) prior to application download and then inserting code to display the selected image at application startup. In a more complex form, depicted in FIG. 21, the publisher can develop the application to allow certain replaceable content 2100 such as multimedia, text strings, or code modules to be replaced at the time of download. At download time, the user can either create his/her own personalized content 2105 or select from a list of replacements provided by the publisher, indicated at 2110, or a combination of both. The instrumentation process removes the replaceable modules from the application package and inserts the replacements selected by the user. For example, many games have background images, which a publisher can allow to be replaced with a user-selected image at download time.

### Networked Game Support

There is a recent trend that publishers have developed mobile games that are network-enabled such that the games automatically post scores to a server or website that is accessible to other users. Such functionality encourages competition between users and can increase game play. However, the majority of applications were not developed with this functionality. The present invention can be used to allow publishers or distributors to easily add such functionality to pre-existing mobile applications, as depicted in FIG. 22. The instrumentation process can add generic code to transmit the score at the end of a game session to a server 2200. The primary difficulty is in determining where in the application code the score is stored, which can be accomplished via, for example, the following two approaches. In the first approach, the analysis phase of the instrumentation process attempts to automatically determine how the score is stored. Typically, at the end of a game, the numeric score is displayed on the screen as indicated at 2205, prefaced (either above or to the left) by text such as “Score:”. The analysis code can search for any locations where the application displays such information (via the platform API javax.microedition.lcdui.Graphics.drawString( )) and then insert code 2210 after the display invocations to transmit the score information to a server 2200. If the first approach is not successful (the analysis code is unable to identify where the score is displayed), then a second approach can be used in which the emulator mechanism described previously presents the application to the publisher (or distributor). The publisher plays the game once within the emulator, and at the end of the game when the score is displayed, the emulator allows the publisher to select the region within the emulator screen in which the score is displayed. The emulator can track the location in the application code that displayed the region selected by the publisher. The instrumentation process can then insert new code at the identified location to send the score information to a server.

I claim:

1. A method for automating code modifications for an application comprising the steps of
receiving an application comprising code and executable on a client device,
automatically identifying locations within the code where additional code can be inserted,
automatically modifying the application by inserting code [at least one of the identified locations] to add predetermined functionality to the application, and
returning the modified application for delivery to the client device.

2. The method of claim 1 wherein the modifying step includes deletion of code from the application.

3. A method for automating modifications to an application comprising steps of
receiving an application comprising code and an application descriptor and executable on a client device,
automatically identifying locations within at least one of the code and the application descriptor where additional information can be inserted,
selecting for modification at least one of the identified locations,
modifying at least one of the identified locations,
returning the modified application for delivery to the client device.

4. The method of claim 3 wherein the additional information includes code.

5. The method of claim 3 wherein the additional information includes text.

6. The method of claim 4 wherein the application is modified by identifying locations within the code where additional code can be inserted.

7. The method of claim 5 wherein the additional information is inserted into the application descriptor.

8. The method of claim 7 wherein the information inserted into the application description includes information specific to the client or the client device.

9. A method for automating modifications to an application comprising the steps of
receiving an application comprising code and data and executable on a client device,
automatically identifying locations within the application where either the code or the data, or both, can be modified,
modifying at least one of the code or the data, and
returning the modified application for delivery to the client device.

10. A method for automating code modifications for an application comprising the steps of
receiving an application comprising code and executable on a client device,
automatically identifying locations within the code where additional code can be inserted,
modifying the application by inserting code in at least one of the identified locations to add predetermined functionality to the application, and
returning the modified application for delivery to the client device.

11. A method for automating code modifications for an application comprising the steps of
receiving an application comprising code and executable on a client device,
identifying locations within the code where additional code can be inserted,
automatically modifying the application by inserting code to add predetermined functionality to the application, and
returning the modified application for delivery to the client device.

12. The method of claim 10 wherein the modifying step is performed automatically.

13. The method of claim 11 wherein the identifying step is performed automatically.

14. A method for automating code modifications for an application comprising the steps of
receiving an application comprising code and executable on a client device,
automatically identifying locations within the code where additional code can be inserted,
returning the application for selection of at least one of the identified locations,
automatically modifying the application by inserting code at the selected location to add predetermined functionality to the application,
repeating the returning and modifying steps as desired, and
forwarding the modified application for delivery to the client device.

15. The method of claim 14 further comprising the step of re-receiving the application following the selection of at least one of the identified locations.

16. The method of claim 15 wherein the re-receiving step is repeated as desired.

17. The method of claim 14 wherein the step of returning the application comprises returning an emulation of the application.

18. The method of claim 1 further including the step of modifying the application by adding user-specific information.

19. A method for automating modifications to an application comprising steps of
receiving an application comprising code and an application descriptor and executable on a client device,
identifying locations within at least one of the code and the application descriptor where additional information can be inserted,
selecting for modification at least one of the identified locations,
automatically modifying at least one of the identified locations,
returning the modified application for delivery to the client device.

20. The method of claim 9 where the data to be rendered comprises at least one of a group comprising audio, video, image, and text.

21. The method of claim 10 wherein the application further comprises data.

22. A method for automating modifications to an application comprising the steps of
receiving an application comprising code and data and executable on a client device,
identifying locations within the application where either the code or the data, or both, can be modified,
automatically modifying at least one of the code or the data, and
returning the modified application for delivery to the client device.

23. The method of claim 1 wherein modifying comprises at least one of a group comprising adding, removing, or substituting.

24. The method of claim 1 wherein the identifying step includes recognizing placeholders.

25. The method of claim 1 wherein the identifying step includes decompiling the application.

26. The method of claim 1 wherein the modifying step includes decompiling the application.

27. A process for distributing content to a wireless device operated by a user comprising the steps of
adapting a pre-existing application to enable the application to include additional content capable of being rendered on a wireless device,
downloading the application to a user's wireless device, and
receiving tracking data from the user's wireless device after the additional content has been rendered.

28. A process for distributing content to a user's wireless device comprising the steps of
modifying a pre-existing application to include additional content capable of being rendered on a wireless device,
downloading the application to a user's wireless device,
detecting a predetermined event, and
downloading to the user's wireless device new content in response to the detection of the predetermined event.

29. The process of claim 28 wherein the predetermined event is the passage of a period of time.

30. The process of claim 28 wherein the predetermined event is a point in the application.

31. The process of claim 28 wherein the predetermined event is the rendering of the initially downloaded content a predetermined number of times.

32. The process of claim 28 further comprising the step of
receiving from the user's device tracking data.

33. The process of claim 28 further comprising the step of
receiving from the user's device distribution data sufficient to allocate compensation.

34. The process of claim 33 wherein the distribution data includes indicia for identifying each distributor associated with downloading of the application to a user's wireless device.

35. The process of claim 27 wherein the additional content is static.

36. The process of claim 27 wherein the additional content is dynamic.

37. The process of claim 27 further comprising the step of
further modifying the pre-existing application to include user-specific information.

38. The process of claim 37 wherein the further modification occurs after the user requests the download and before the download occurs.

39. The process of claim 33 wherein the receiving step is not contemporaneous with the rendering of the additional content on the user's device.

40. The process of claim 39 wherein the distribution data is stored on the user's wireless device at least until the receiving step occurs.

41. A method of distributing content to a user's wireless device comprising the steps of
adapting a pre-existing application to enable the application to include additional content capable of being rendered on a wireless device,
receiving a request for download,
receiving user-specific information,
modifying the application to include user-specific information, and
downloading the modified application to a user's wireless device.

42. The method of claim 41 further comprising the step of
receiving from the wireless device information sufficient to track the rendering of the additional content.

43. The method of claim 41 further comprising the step of
receiving from the wireless device information sufficient to track the rendering of the additional content.

44. The method of claim 41 further comprising the steps of
detecting a predetermined event, and
further modifying the application after detecting the predetermined event.

45. The method of claim 41 further comprising the step of modifying the application to include content selected based on the user-specific information.

46. The method of claim 28 wherein the predetermined event is a schedule.

47. The method of claim 41 wherein the user-specific information is the manufacturer and model of the wireless device.

48. A method of distributing content to a user's wireless device comprising the steps of
adapting a pre-existing application to enable the application to include additional content capable of being rendered on a wireless device,
receiving a request for download,
receiving information specific to the user's wireless device,
modifying the application to include device-specific information, and
downloading the modified application to a user's wireless device.

49. The method of claim 41 wherein the user-specific information comprises at least one of a group comprising the user's service provider, the user's residence, the user's device, the user's demographic data, and the user's current location.

50. The method of claim 41 wherein the request for download originates with a user's device.

51. The method of claim 41 wherein the request for download originates with a web site.

52. A method for instrumenting an application adapted for execution on a wireless device comprising the steps of
receiving an application comprising code and executable on a client device,
receiving data specific to at least one of a group comprising the user or the user's device,
modifying the application in accordance with the data by inserting code to add predetermined functionality to the application.

53. The method of claim 52 wherein the data is received at substantially the same time as a download of the application is requested.

54. The method of claim 52 wherein the data includes at least one of a group comprising the user's service provider, the user's location, the user's device, the user's country of residence, and the user's demographic data.

55. The method of claim 52 further comprising the step of
transmitting to a server tracking data indicative of the user's interaction with the modified application.

56. The method of claim 52 wherein the modifying step further includes inserting content.

57. The method of claim 56 wherein the content provided to the application is selected in accordance with the data received in the receiving step.

58. The method of claim 56 wherein at least some of the content provided to the user's device on a subsequent execution of the application is different from the content provided to the user's device on the first execution of the application.

59. The method of claim 52 wherein the data comprises information about the identification of each distributor associated with a download by the user.

60. A method for rendering advertisements on a wireless device comprising the steps of
providing to the wireless device an advertisement capable of being rendered on the device,
caching the advertisement on the wireless device,
retrieving from cache and rendering the advertisement in accordance with a predetermined criteria resident on the wireless device.

61. The method of claim 60 wherein an advertisement includes logic.

62. The method of claim 60 wherein an advertisement includes at least one, image.

63. The method of claim 60 wherein an advertisement includes an audio portion.

64. The method of claim 60 wherein the predetermined criteria is provided to the wireless device contemporaneously with the advertisement.

65. The method of claim 60 wherein the predetermined criteria is provided to the wireless device prior to providing the advertisement to the wireless device.

66. The method of claim 60 wherein the predetermined criteria is provided to the wireless device subsequent to providing the advertisement to the wireless device.

67. The method of claim 60 wherein the predetermined criteria includes at least one of a group comprising: an end date for the advertisement, time of day, location of the wireless device, prior advertisement sequence, and targeting information.

68. The method of claim 60 wherein the predetermined criteria includes selecting subsequent ads based on the rendering of a prior ad.

69. The method of claim 60 wherein the predetermined criteria includes selecting subsequent ads based on the user's interaction with an ad rendered previously.

70. The method of claim 68 wherein the predetermined criteria includes selecting a series of ads sequentially.

71. The method of claim 67 wherein the rendering of a first ad at the beginning of an application causes the selection of a second ad later in the application.

72. The method of claim 60 wherein the predetermined criteria is downloaded to the wireless device as part of the advertisement.

73. The method of claim 60 further including the step of providing a plurality of available actions selectable by the user in response to the user's selection of an ad.

74. The method of claim 60 wherein the ad includes a video portion.

75. The method of claim 60 wherein the ad includes an audio clip.

76. The method of claim 73 where the plurality of available actions includes a plurality of URLs.

77. The method of claim 60 further comprising the step of recording information indicative of the rendering of the advertisement.

78. The method of claim 60 further comprising the step of recording information indicative of a user interaction with the advertisement.

79. The method of claim 60 further comprising the step of recording information indicative of a result of a user interaction with the advertisement.

80. The method of claim 77 further comprising the step of providing to a remote server the recorded information.

81. The method of claim 78 further comprising the step of providing to a remote server the recorded information.

82. The method of claim 79 further comprising the step of providing to a remote server the recorded information.

83. The method of claim 79 wherein the ad includes a video portion.

84. The method of claim 79 wherein the ad includes an audio clip.

85. A method for displaying advertisements on a wireless device comprising the steps of
providing to the wireless device an advertisement capable of being rendered on the device, and
providing a plurality of user-selectable actions in response to predetermined user interaction with the advertisement.

86. A method for displaying advertisements on a wireless device comprising the steps of
providing to the wireless device an advertisement capable of being rendered on the device, wherein the advertisement includes a plurality of user-selectable actions in response to predetermined user interaction with the advertisement, and
rendering the advertisement as required by an application resident on the wireless device.

87. A method of distributing advertisements in a campaign to wireless devices comprising the steps of
identifying a number of impressions of an advertisement expected for a campaign, and
downloading, during one or more downloads, an application and the advertisement to a quantity of users, where the potential quantity of resulting impressions is in excess of the expected number of impressions.

88. The method of claim 87 further including the step of
recording, on the wireless device, an indicia indicative of the rendering of the advertisement.

89. The method of claim 87 further including the step of
reporting the impression at a time not contemporaneous with the download of the application and advertisement.

90. The method of claim 88 further including the step of
reporting the impression at a time not contemporaneous with the download of the application and advertisement.

91. The method of claim 87 wherein the a single user is predicted to receive multiple impressions of the advertisement.

92. The method of claim 87 wherein a single user is predicted to receive at least one impression of the advertisement.

93. A method of organizing an ad campaign comprising the steps of
receiving at least one creative, the creative being provided in a plurality of formats, wherein each of the plurality of formats is compatible with one of a plurality of device types,
organizing the at least one creative according to compatible device types,
serving an appropriate format of the at least one creative in accordance with a user's device type.

94. A method for distributing revenues among one or more participants associated with the distribution of electronically distributed data comprising the steps of
providing data for download by a user,
modifying the data to store therein an indicia representative of at least one participant in the distribution,
apportioning at least a portion of the revenues in accordance with the stored indicia.

95. The method of claim 94 wherein the at least one participant comprises at least one of a group comprising developer, publisher, distributor, infrastructure provider, agencies, advertiser and user.

96. The method of claim 95 wherein the at least one link is at least two links.

97. The method of claim 95 wherein the data is download to a wireless device.

98. The method of claim 97 wherein the wireless device is at least one of a group comprising cellular phone, PDA, smart phone, portable game console, handheld computer.

99. The method of claim 95 wherein the data is an application.

100. The method of claim 95 wherein the data is content.

101. The method of claim 95 where the data is a message.

102. A method for assigning charging rates for electronically distributed downloadable data comprising the steps of
inserting into downloadable data direct or indirect indicia of a user's demographic factors,
providing the data to the user,
characterizing additional data in accordance with a demographic criteria,
serving to the user the additional data, and
charging for the additional data provided based on a correlation of the demographic factors with the demographic criteria.

103. The method of claim 102 wherein the user's demographic factors are correlated prior to download of the additional data.

104. The method of claim 103 further including the step of authorizing the download only where the correlation meets a predetermined threshold.

105. The method of claim 102 wherein the step of charging comprises charging different rates depending upon the degree of correlation.

106. The method of claim 102 wherein the user's demographic factors are correlated after the additional data is downloaded.

107. The method of claim 106 wherein the step of charging comprises charging different rates depending upon the degree of correlation.

108. The method of claim 102 wherein the demographic factors are determined in accordance with at least one of the following group: cookies, survey information, phone number, device serial number, device email address, device direct connect number, device cell ID, device GPS location, web traffic header information, carrier gateway address.

109. The method of claim 102 wherein the user is assigned a unique ID and the demographic factors are associated with that user ID.

110. A method for assigning charging rates for electronically distributed downloadable data comprising the steps of
inserting into downloadable data at least one direct or indirect demographic criteria,
providing the data to a user having identifiable demographic factors,
comparing the user's demographic factors with the demographic criteria,
charging for the data provided based on correlation of the demographic factors with the demographic criteria.

111. A method for downloading advertising to a wireless device with minimal disruption to a user's perception of the operation of an application running on the device comprising the steps of
establishing a first thread for running the application on the wireless device having a user interface, and
establishing a second thread for downloading of the advertising substantially without interacting with the user interface.

112. The method of 111 wherein the advertising is configured to avoid substantial interaction with the user interface while also not altering the device's internal controls for prioritizing between the first and second threads.

113. The method of claim 111 wherein the size or type of the advertising content is configured to avoid substantial interaction of the second thread with the user interface.

114. The method of claim 111 wherein the frequency of the download is limited to avoid substantial interaction of the second thread with the user interface.

115. A method for charging advertisers for ads downloaded to a wireless user device for display in conjunction with a mobile application comprising the steps of
downloading an application to a wireless user device,
downloading to the wireless user device an ad which is available for display to a user during the running of the application,
storing on a server an indicia indicative of the rendering of the ad on the wireless user device where the storing is not contemporaneous with the rendering of the ad, and
generating a charge for the rendering of the ad.

116. The method of claim 115 further including the steps of recording, on the wireless user device, the rendering of the ad thereon and communicating to the server a signal indicating the occurrence of the rendering.

117. The method of claim 115 wherein the indicia indicative of the rendering of the ad is generated in accordance with a statistical model of expected user behavior.

118. A method for charging advertisers for ads displayed on a wireless device comprising
downloading at least one ad to a wireless device,
charging a first fee for the download of the ad,
making the ad available to a user of the wireless device,
storing on a server an indicia representative of the rendering of the ad by the user, and
charging a second fee for the rendering of the ad by the user.

119. A method for assigning charging rates for electronically distributed downloadable data comprising the steps of
inserting into downloadable data meta-data related to at least one characteristic of the data,
constraining display of the data in accordance with the meta-data, and
varying the charge to the advertiser in accordance with the meta-data.

120. The method of claim 119 wherein the at least one characteristic is selected from a group comprising: CPM, CPA, ad priority, ad sequencing information, ad placement directives, desired impressions frequency, desired maximum impressions, desired duration of each impression, desired impression time-of-day/week/month/year, desired impression geographic locations, ad expiration date.
